(19) United States
(12) Patent Application Publication
(10) Pub. No.: US 2019/0220259 A1
(43) Pub. Date: Jul. 18, 2019

(54) 3D MULTI-THREADED, PARAMETER LAYERED, PHYSICAL PROGRAMMING INTERFACE

(71) Applicant: Algobrix Ltd, Nes Ziona (IL)

(72) Inventor: Amir ASOR, Nes Ziona (IL)

(21) Appl. No.: 16/312,752

(22) PCT Filed: Jun. 25, 2017
(86) PCT No.: PCT/IL2017/050700

§ 371 Date: Dec. 21, 2018

(30) Foreign Application Priority Data
Jun. 30, 2016 (IL) 246551

(51) Int. Cl. G06F 8/41; A63H 33/04; A63H 33/08; A63F 13/23

(52) U.S. Cl. CPC G06F 8/456; A63H 33/042; G09B 19/0053; A63F 13/23; A63H 33/08

(57) ABSTRACT

A physical programming interface with a multi-threaded command sequencing which distinguishes between functions and parameters, by separating them to different planes (horizontal and vertical), and associates the parameter quantitative size and it's functionality with their physical appearance and dimensions. The association also enables an automatic physical debugging system to prevent the user from compilation errors by one-to-one or one-to-many relationship, or using lights to inform on functional errors.

### FIELD OF THE INVENTION

The present invention relates to a physical programming interface with a multi-threaded command sequencing, which distinguishes between functions and parameters, by separating them to different planes (horizontal and vertical), and associates the parameter quantitative size and its functionality with their physical appearance and dimensions. The association between the functionality and the physical appearance also enables an automatic error prevention system by one-to-one relationship, i.e., each parameter has a unique receptor in the function block. The system also enables debugging by using lights to inform on functional errors.

### BACKGROUND OF THE INVENTION AND PRIOR ART

Teaching robotics, computer programming and engineering skills to young learners has recently been growing in popularity due to changes in recent technology and the growing need for capable programmers [“Take a giant step: A blueprint for teaching children in a digital age” Barron, B. et al, (2011)]. [“Transforming American Education: Learning Powered by Technology”. U.S. Department of Education (2010)]. However, there is a constant shortage in programmers due to the complexity of learning and the built in barriers of programming [“Integration of Innovative Technologies and Affective Teaching & Learning in Programming Courses” Prasad et al, (2015)]. Thus, there is a need for a flexible and wide-ranged intuitive physical programming interface which demonstrates the following coding elements for non-programmers:
Command sequencing.
Multi-threading in every coding stage
Clear distinction between functions and parameters of the functions.
Intuitive visualization of the parameter functionality and scales, e.g. connecting the object dimensionality to its programmable value.
Automatic error prevention to avoid user frustration due to compilation errors.
Debugging a specific command, which will be referred as the “me button”.

In the last two decades there has been a growing interest on how to develop such a physical programming interface where a large variety of products have been introduced. However, none of them was able to satisfy all the required elements. In 2012 a company called Sifteo Cubes suggested a semi-stage for physical programming by using Siftables which are small computers with a graphical interface. The small computers were able to communicate with each other to generate simple computer program. However, each cube is highly expensive and the interface is not physical but rather graphical, using separated small computers. This problem is emphasized by the parameters, which are selected in the graphical touch screen and not connected to physical objects and their characteristics.

In 2011 Modular Robotics Studio introduced the concept of Cubelets, which were small plastic blocks designed to magnetically snap together for the construction of robots. Each block contains its physical meaning (i.e. light, sensor type, movement . . . ) and communicates with each other. Once the blocks are physically connected, they begin to operate without a physical programming interface. This interface has several disadvantages in the teaching of coding, as each block is “alive” and its parameters cannot be reconfigured.

In 2014 Primo Toys launched Cubetto, which was a hands on coding program with physical elements. Their initial robot and programming kit was enhanced in March 2016. The current product includes a wooden robot and plastic blocks with electronics. Each block is a physical representation of an unambiguous instruction code (right, left, forward, backward). The coding is conducted on the horizontal plane by placing the plastic blocks. Cubetto has also similar drawbacks as discussed before: there is no clear distinction between function and parameters, Multi-threading is not possible etc.

In 2008, Hsieh et al., [U.S. Pat. No. 7,316,567], suggested a toy for teaching programming based on stackable blocks, where each one of them has a memory for storage of at least one computer program and they are all the same. The blocks are mechanically stacked and electrically connected to form a computer program. The connected blocks are transmitting the program to a robot for execution. However, U.S. Pat. No. 7,316,567 does not differentiate between function blocks and parameter blocks since all the programming is conducted based on stacking. U.S. Pat. No. 7,316,567 also allows for multi-threading by stacking different blocks to generate several functions. However, this method is limited since only the height dimension locates the sequencing interface, which means the branching process can only be conducted at the beginning of the program.

In 2014 Sullivan et al. introduced KIBO which was a robotic demo for teaching children how to program [“KIBO robot demo: engaging young children in programming and engineering” Sullivan et al., (2015)]. KIBO is programmed using physical wooden blocks which, do not contain any electronics but instead, each block had a unique barcode. KIBO has an embedded scanner, which allows the user to scan and interpret the coding sequence. However, it allows neither threading, nor parameter control.

In Jun. 27, 2016, Google introduced the Project Bloks which was based on the Tern Tangible Programming, and which very similar to KIBO, is a physical programming interface where programming can be conducted in one plane (vertical or horizontal). The programming is conducted by using a Brain Board, Base Boards, and Pucks. The brain board activates the entire program. Functions are determined by Base Boards, where their functionality is defined by the Pucks which are placed on top of them. Each Puck contains one instruction, which means that each Base Board can contain a function with one parameter only. The basic Puck is flat or has a 3D graphics imprinted on it, which means that physical dimensions do not correlate with the logical value. The physical connections of the Brain Board and Base Boards include 2 physical connections for the Brain Board and 4 connections (1 male, 3 females) to the Base Board. This structure does not use the full 4 directional possibilities of physical programming. For example, threading in four directions straight from the Brain Board is not feasible. In addition, the 1 male\3 females structure doesn't allow for a cube to receive inputs from more than one prior cube (e.g. an if statement, or combine threads . . . ). Another important issue is that the interface does not distinguish between functions and parameters, meaning that each function receives only one parameter scale creating a limited flexibility, for example, if a function requires summing its duration period of 2 seconds and also adding external duration value, such as value from sensor or a value from calculator function. This limits the programming possibilities as in many cases one would like to change more than one parameter in the function, i.e. controlling a motor's speed, power and duration all at once.

In addition to the above mentioned problems, all of the current methods address the issue of debugging the program in a rather limited way. For example, U.S. Pat. No. 7,316,567, suggests stacking of same blocks, which cannot support mixture of commands. None of them is offering the possibility to run a specific block to activate a specific function, i.e. it is not possible to use a “me button”. In addition, none of the above has a run-time debagging system to spot the function, which performed on a real time by the external device (PC, Robot, Motor etc.).

The present invention solves the foregoing problem by using the 3D space as the physical programming playground, as hereunder explained.

### SUMMARY OF THE INVENTION

In the present invention, the code visualization is conducted by using three main building blocks: function block, parameter block and the programmed element (motors, sensors, robots, PC). Each function block includes a microcontroller, which allows communication with its neighboring function blocks, distinguishing between function blocks, reading data from parameter blocks and controlling the programmed element.

The present invention separates between function blocks and parameter blocks using different dimensions and different physical axes. The function blocks are placed in the horizontal 2D plane, while the parameter blocks are placed in the vertical plane. Placing the function blocks in the horizontal plane allows for multi-threading at every point of the program. This is important for even a simple program, which wants to activate different motors in different events of the program independently. In addition, using the vertical plane for the parameter blocks generates a clear correlation between the embodiment of the block (its physical vertical size) and its quantitative representation.

Error prevention is conducted by adding complexity to the system of different blocks, which represent different types, correlate with their physical meaning (i.e. a stop shape for stop command) and prevents the user from placing blocks, which may lead to compilation errors by controlling their physical connections. Finally, this interface generates a clear visualization of the coding sequence.

The system allows for bidirectional communication, during runtime, between function blocks and the programmed element so that, at any given running time, user may know which function block is running by adding notification lights. I.e., when a function block is active (in the programmed element), a led is turned on in the operative function block.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. It is understood that the phraseology and terminology employed herein is not to be construed as limiting and are for descriptive purpose only.

### BRIEF DESCRIPTION OF THE DRAWINGS

FIG. 1—is a perspective view of invention's component: Function Block (100), Parameter Block (200), Play Block (300), and the Programmed Elements (400).

FIG. 2—Is front, top, and bottom view, showing the way Function Blocks and Play Blocks are interlocked on Base Plate (500).

FIG. 3—is a schematic circuit diagram of one embodiment of the present invention, showing the connection of a plurality of Function Blocks (100(1)), (100(2)) and Play Block (300). The numbers in inverted commas indicate order of movements and Spring-Based (600) shows the connection for data and current flow.

FIG. 4 is a schematic circuit diagram showing the connection between a Function Block and Parameter Blocks. This figure also illustrates a physical correlation between different Parameter Blocks logical values to their physical dimension.

FIG. 5 is a schematic circuit diagram of another embodiment of the present invention, showing the connection of a plurality of blocks, standard size non-stackable parameters (200a); standard size stackable parameter (200b); 3 standard size stackable parameters (200c) and triple size stackable parameter (200d), all formulating a specific program to a Programmed Element using wired or wireless communication.

FIG. 6 is a top perspective view of an example for a Function Block with its various parameters.

FIG. 7 is a top perspective view of parameter block.

FIG. 8 is a schematic circuit diagram, showing program over a Physical Programming Interface using single multi-threading by a Function Block or by a Play Block.

FIG. 9 is a schematic circuit diagram showing program over a Physical Programming Interface using plurality of multi-threading by a Function Block.

FIG. 10 is a chronical flowchart showing a code transmitted to the robot, corresponding to FIG. 9 hereto.

FIG. 11 is a schematic circuit diagram of one embodiment of the present invention, showing a Function Block that returns a value, which is used by other Function Blocks.

FIG. 12 is a schematic circuit diagram showing the Electrical Connectivity (700) between Function Block to one or more Parameter Blocks.

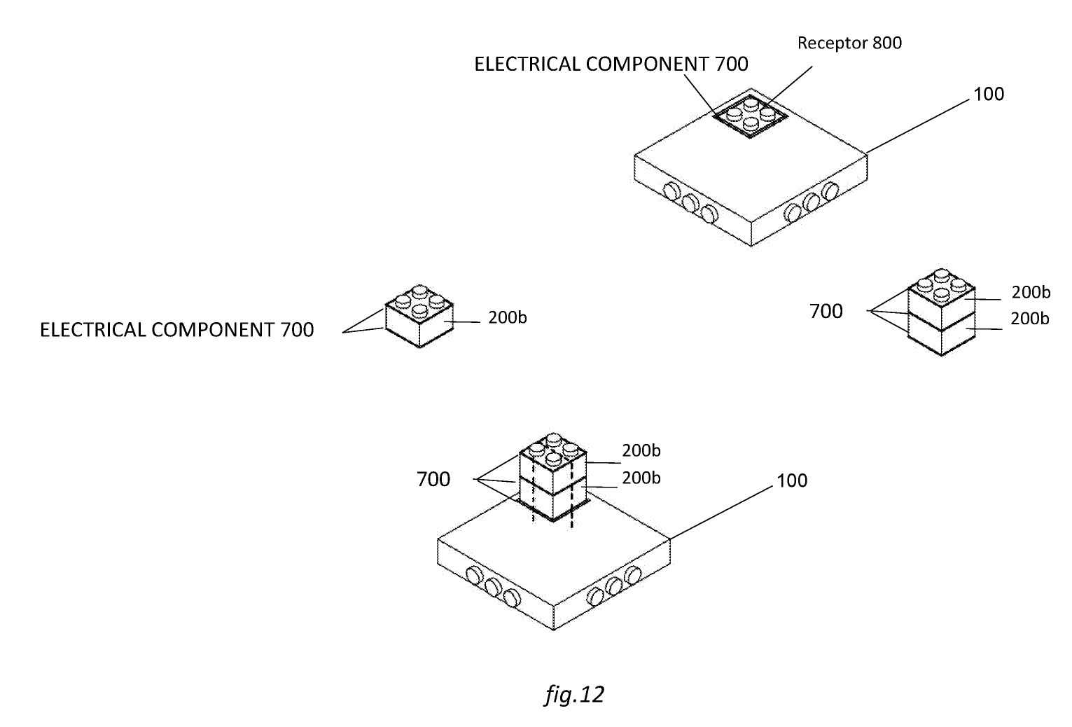

FIG. 13 shows a Function Block which lights up to indicate that this is the specific Function Block currently activated in the Programmed Element.

FIG. 14 shows Error Prevention by using one-to-one relation between Receptor (800).

FIG. 15 shows Error Prevention when there is a logical error in the Function flow.

FIG. 16 is a schematic circuit diagram of one embodiment of the present invention, showing one Function Block, which reads data from two Function Blocks.

FIG. 17 is a schematic embodiment of the present invention showing the “me button” (900(a)). The “Me button” is positioned on a function block allowing user to run a specific function block out of a series of connected function blocks without activating the entire program sequence.

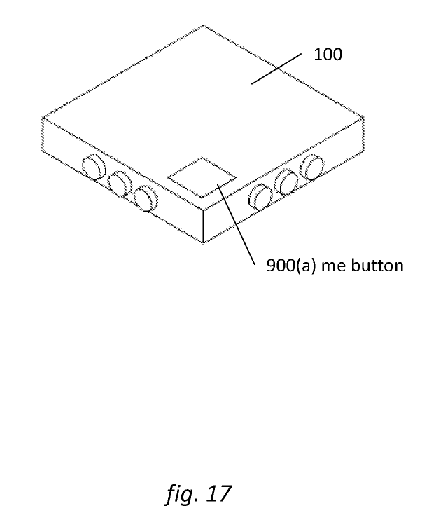

FIG. 18 is a schematic circuit diagram showing how a program made out of several Function Blocks (100(2)), (100(3)) may be stored for reuse in other instances using a save Function Block (100a) by pressing the “me store button” (900(b).

FIG. 19 is a schematic circuit diagram showing how the user may change parameters of a Stored Program dynamically.

FIG. 20 is a schematic circuit diagram showing a Stored Program communicating with a computer or a tablet wired or wireless.

FIG. 21 is a schematic circuit diagram showing how a Parameter Plate (1000) may be used to extend the number of Parameter Blocks, which can be used as inputs in the Stored Program.

FIG. 22 is a schematic circuit diagram showing how a Play Block (300) may control different Programmed Elements (400).

### DETAILED DESCRIPTION OF THE PREFERRED EMBODIMENTS

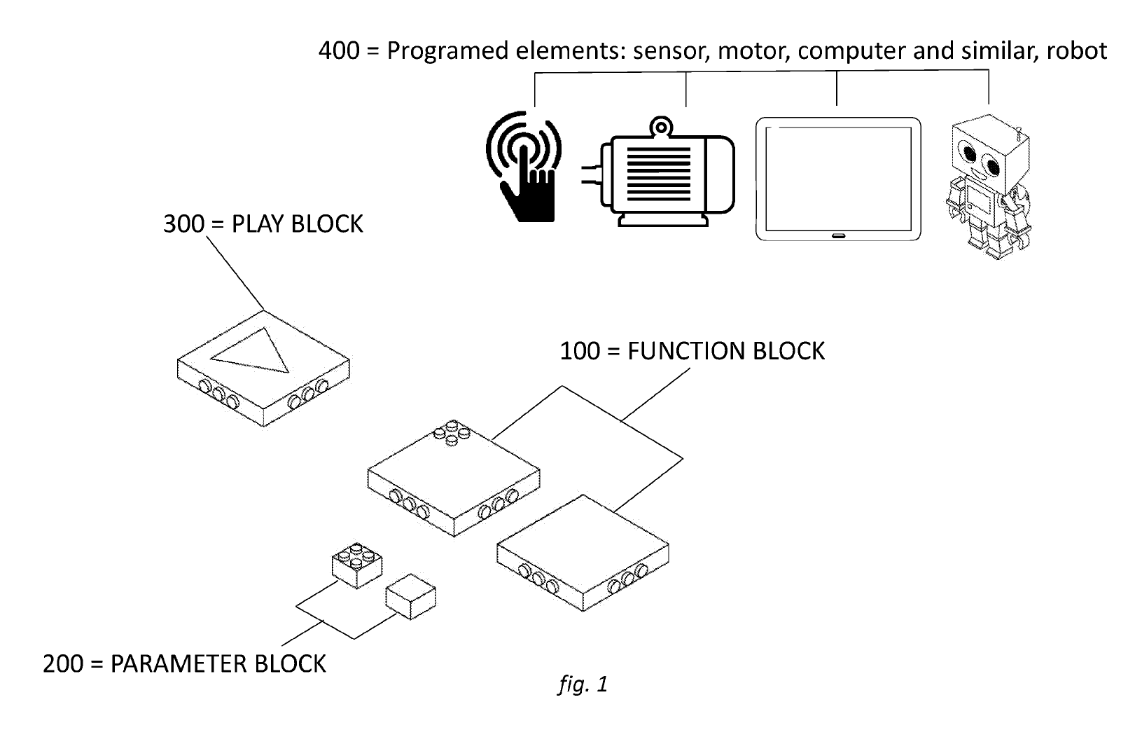

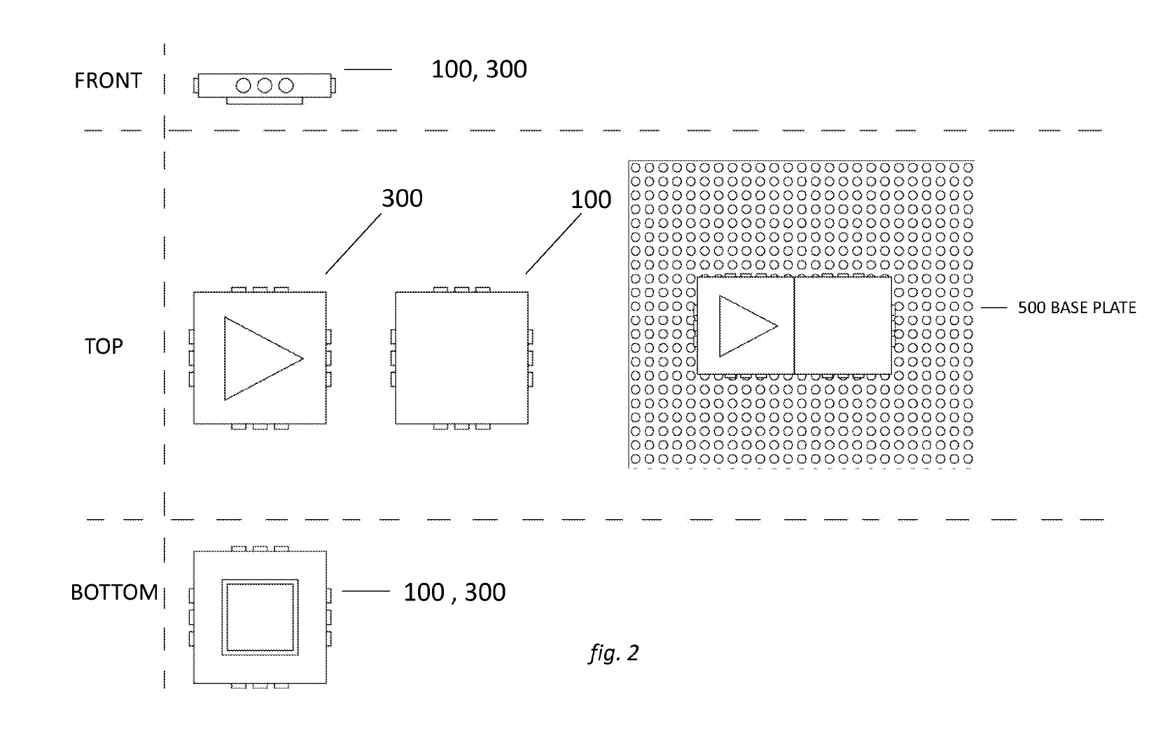

FIG. 1, shows a perspective view of invention's components: Play Block (300), Function Block (100) and Parameter Block (200) and the Programmed Elements (400). The Play Block and Function Block (100) are placed on an interlocked Base Plate (500) to ensure conductivity between every Function and Play Blocks, (FIG. 2).

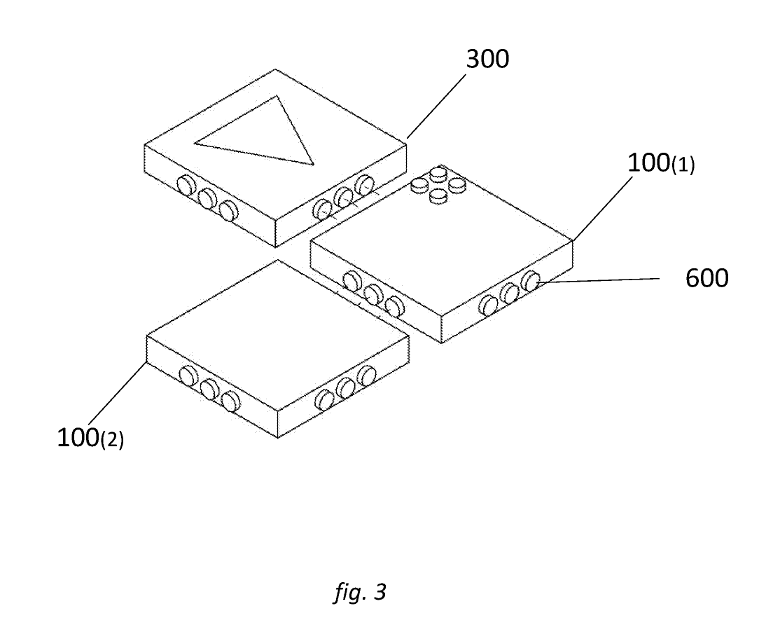

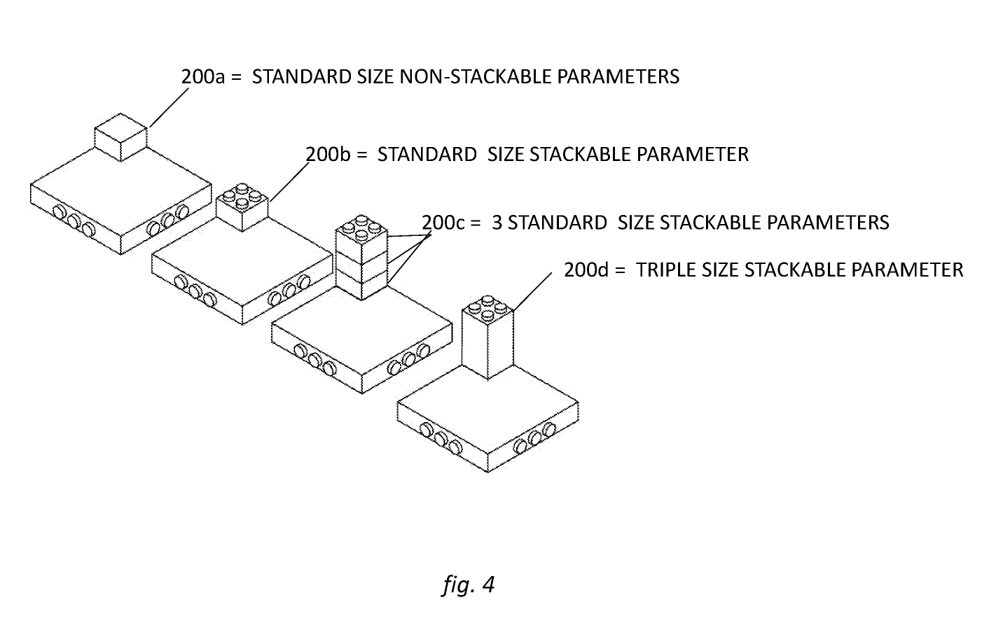

A Spring-Based (600) connection for data and current flow is shown in FIG. 3. Each Play Block (300), and Function Blocks (100(1)) & (100(2)) are connected by one or more Spring-Based (600) which are electrical connectors allowing data and current flow, FIG. 3. Electrical plurality connections of Parameter Blocks (200) are shown in FIG. 4. In addition, Parameter Blocks (200) may be: standard size non-stackable block (200(a)), standard size stackable block (200(b)), multiple standard size non-stackable block (200(c)) and stackable blocks (200(d)), to enable the correlation between their physical dimensions (height and width) and its logical values.

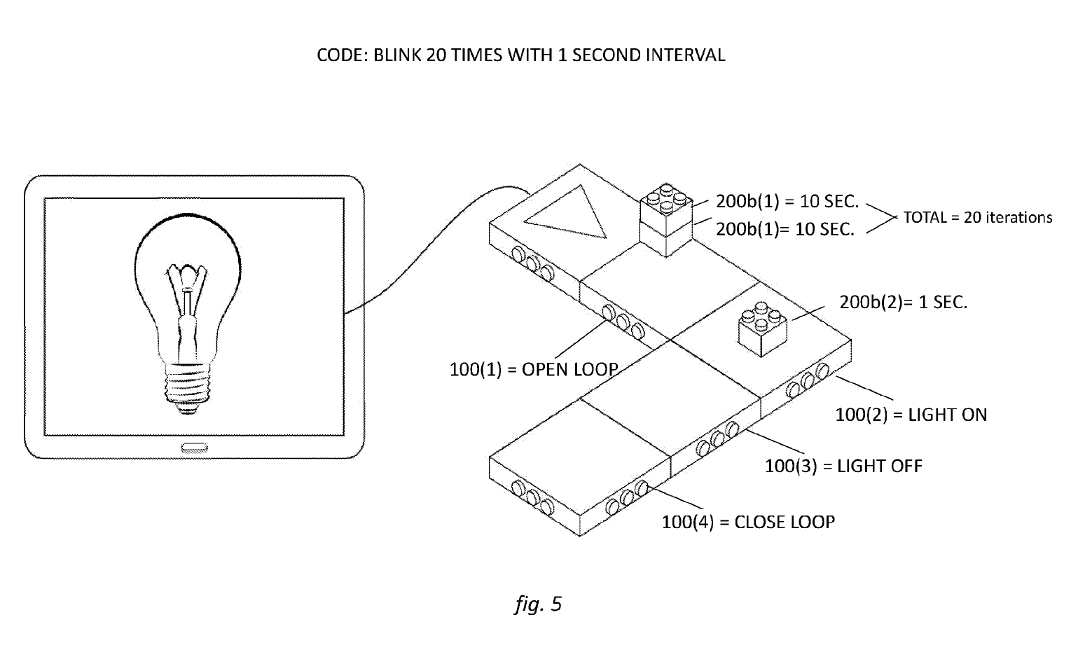

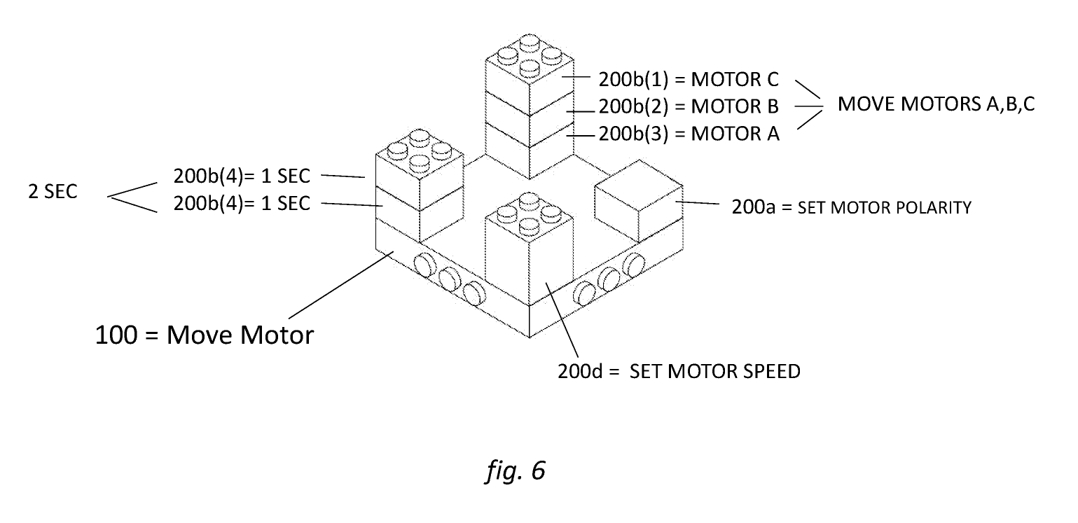

In order to formulate a program using the current invention, user needs at least one Play Block (300) to communicate with the Programmed Element (400) and one Function Block (100) to determine a specific function. Parameter Blocks (200) may or may not be included according to the requirement of the function. Meaning that a program may include more functions and parameters in different combinations. For example, read from sensor Parameter Block (200) may be stacked over a 2 seconds Parameter Blocks (200) (FIG. 6). Another example is a diagram of an embodiment meant for generating a light blinking code for 20 times of the Programmed Element (400) (FIG. 5).

Play Block (300) is connected to Function Block (100(1)), which has two Parameter Blocks (200b(1)). Each of Parameter Blocks (200b) holds the information for 10 iterations, thus forming a repetition of 20 iterations in total (FIG. 5). Following Function Block (100(2)) activates the light for one second followed by light closing Function Block (100(3)). The last Function Block, which determines the end of the code, is close loop Function Block (100(4)).

Parameter Blocks (200) may be in different embodiments and different shapes in order to illustrate a correlation between their physical and logical values. For example, FIG. 6 shows a specific Function Block (100) (Move Motor) with various Parameter Blocks (200):

(1) Operate motor A (200b(1)), Motor B (200b(2)), and Motor C (200b(3)),
(2) Set motor polarity (200(a)), which determines the turning direction of Move Motor (100) (clockwise or counter clockwise)
(3) The duration of motor (200b(4)) and motor speed (200(d)).

Parameter Blocks (200), which are used, were previously introduced in FIG. 4.

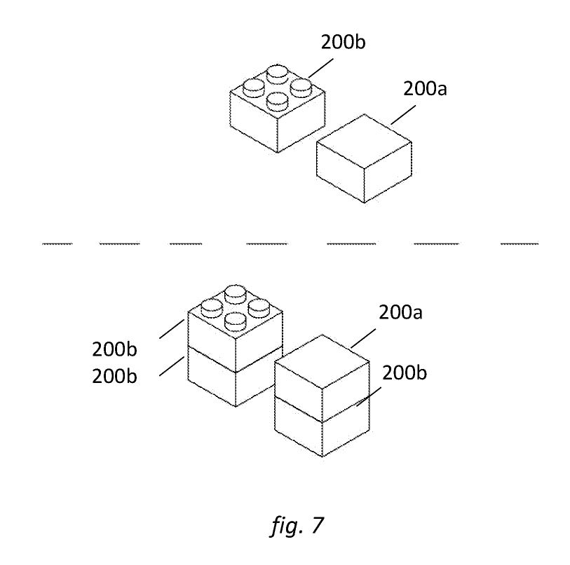

Parameter Blocks (200) may come as stackable (200(b)), non-stackable (200(a)) and in different combinations thereof as shown in FIG. 7, where stackable Parameter Block (200(a)) is placed on another stackable Parameter Block (200(a)) and a non-stackable Parameter Block (200(b)) is placed on a stackable Parameter Block (200(a), thus allowing combination of Parameters Blocks (200) from different families (Values obtained from sensors, constant, or others).

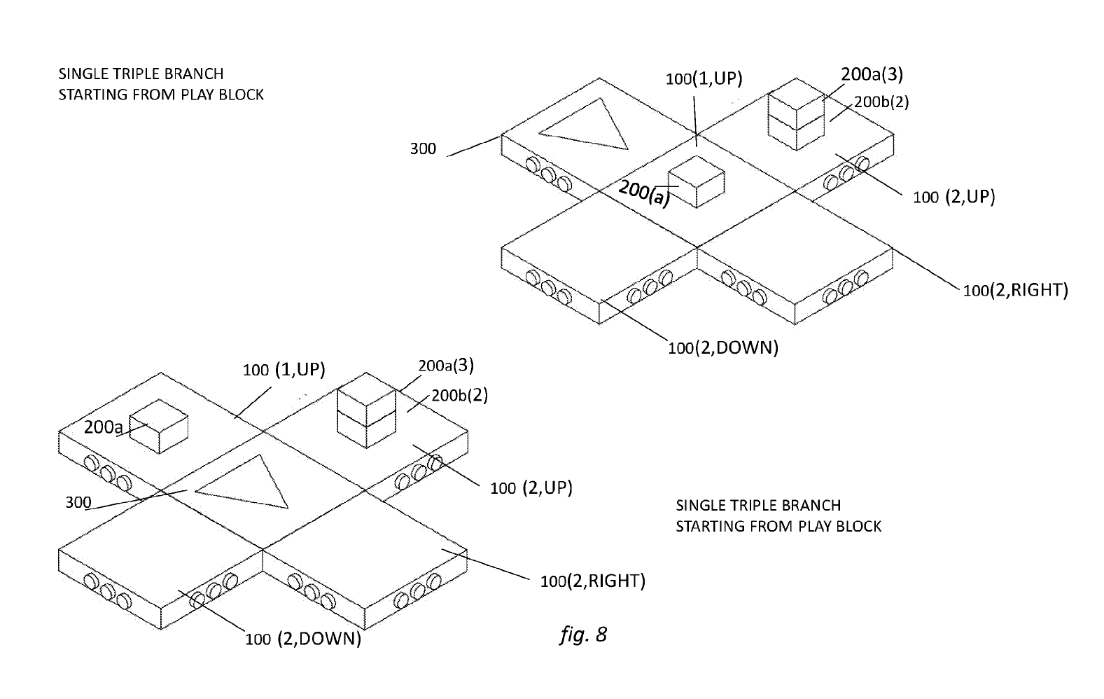

The invention also enables code branching in each one of Play Blocks (300) and Function Blocks (100) of the code. As Play Blocks (300) and Function Blocks (100) contain electronic conductors on all sides, as shown on FIG. 8, where three code branching may occur in any of them.

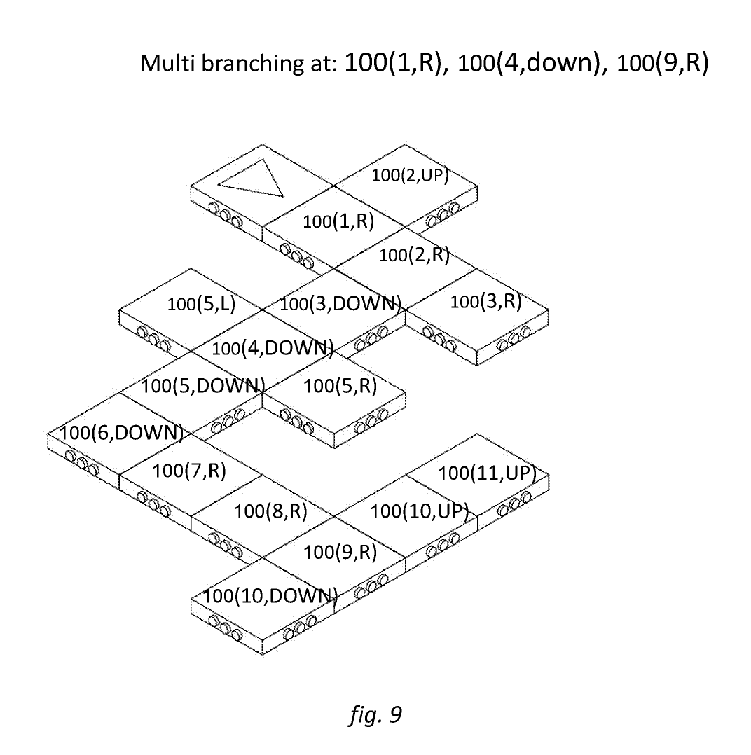

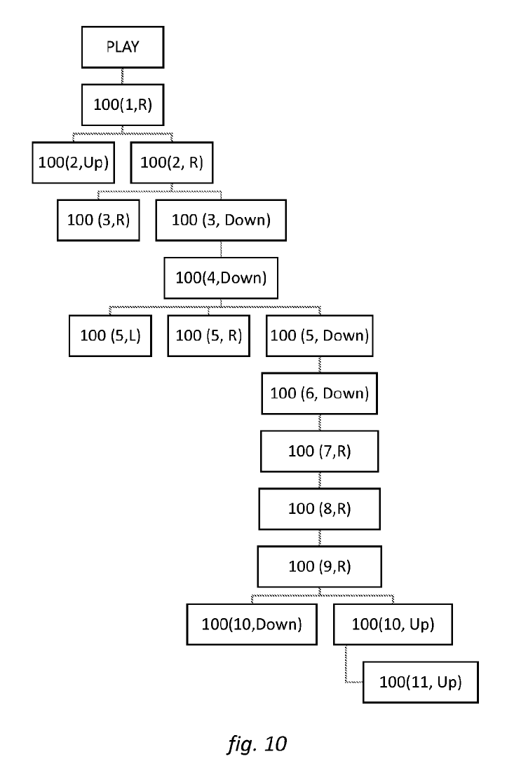

The invention is not limited to squared shapes only, and Function Block (100) may create a rectangle with N walls of Function Block (100), the branching code enables (N−1) branches from every branching point in the code. Furthermore, there is no limitation for code branching as shown in FIG. 9. A flow chart of the code is shown in FIG. 10, demonstrating the hierarchy of the code in one direction (up to down).

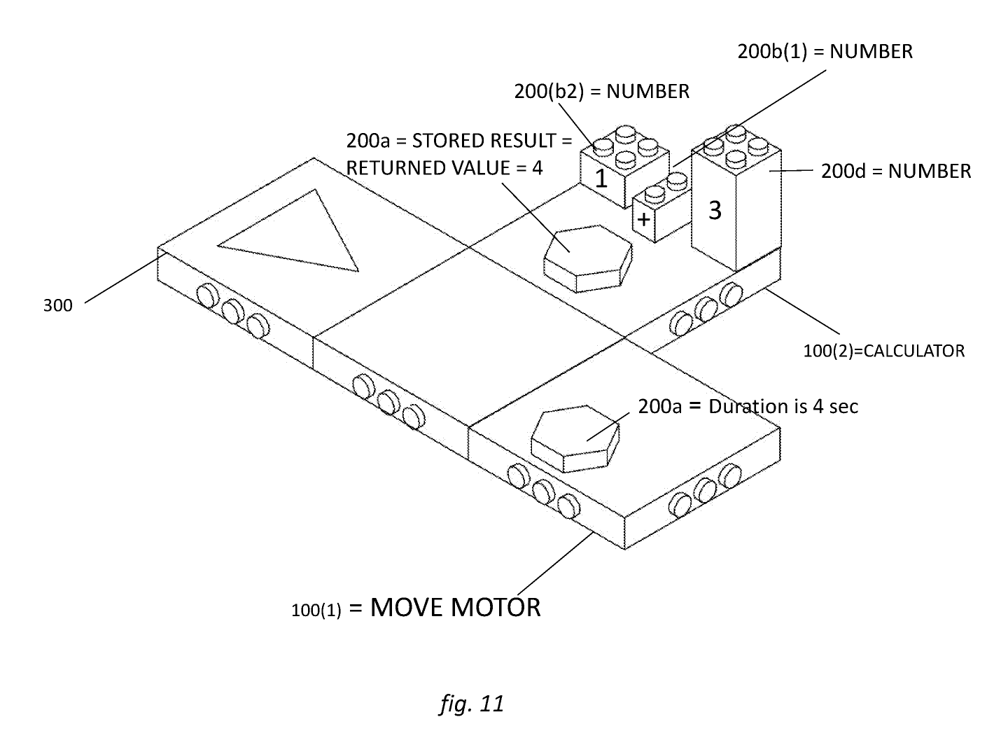

The invention may also demonstrate the concept of pointers, in which one Function Block (100) points to another Function Block (100), without the need to be directly connected to it; this concept simulates using pointers in programming. FIG. 11 demonstrates how a Move Motor Function Block (100(1)) may use a result calculated by Calculator Function Block (100(2)). A logical operation of “add” is conducted between two Parameter Blocks (200b(1)) & (200(d)) using operator Parameter Block (200b(2)). The result is represented by Parameter Block (200(a)), which also appears on move motor Function Block (100(1)), thus allowing the use of the calculated result for other Function Blocks (100).

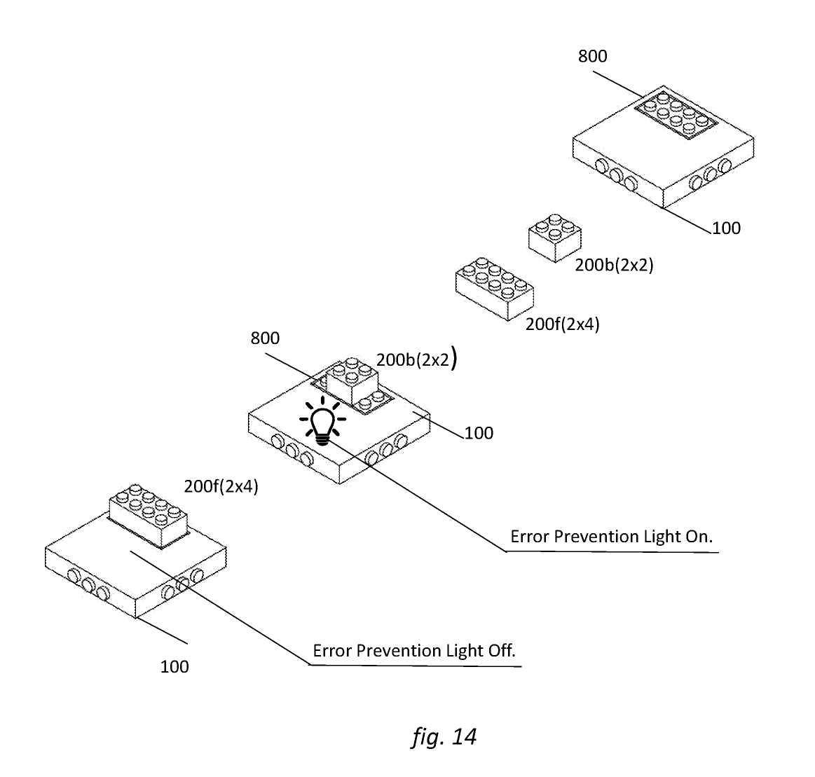

Each of Parameter Blocks (200), which are placed, (in a stackable or non-stackable manner), on Function Block (100) have a specific value, which is transmitted to Function Block (100) using Electrical Components (700) (FIG. 14.

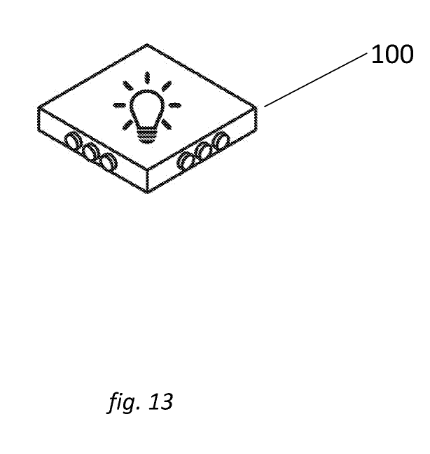

The invention also enables a runtime debugging by lighting up Function Block (100) whenever Programmed Element (400) performs a specific corresponding Function Block (100), (FIG. 13).

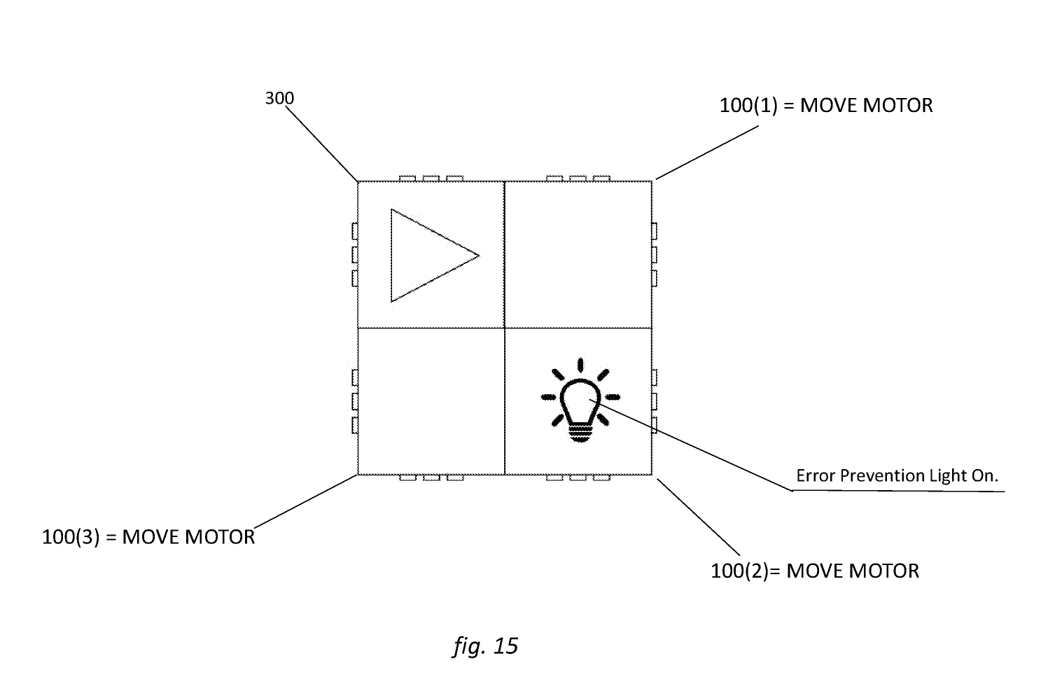

The invention also enables Error Prevention mechanisms in two ways: (1) the physical size of Parameter Block (100), which has to be similar to Receptor (800) of Function Block (100). In case of placing an unsuitable shape of Parameter Block (200) on Function Block (100), an Error Prevention light turns on (FIG. 14). Similar Error Prevention takes place when creating a circular hierarchy (FIG. 15). In this case, the thread, which Function Block (100(2)) is part of, is not well defined, as it may be considered as part of two threads: (1) as part of the thread going out from the right wall of Play Block (300) through Function Block (100(1)), or (2) as part of a thread going out from the bottom wall of Play Block (300) through Function Block (100(3)).

Such hierarchical failure described hereto lights up an Error Prevention notification on Function Block (100(2)). Nevertheless, the invention may connect two threads into one Function Block (100) using ‘Read from Function’ of Function Block (100).

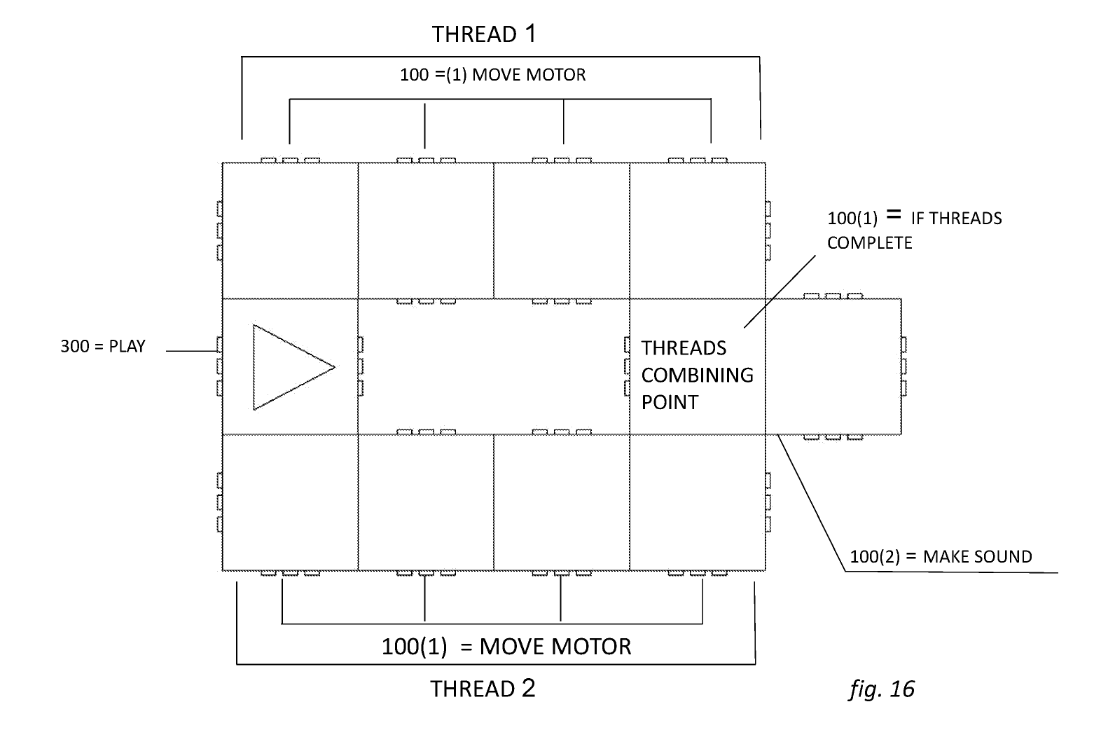

FIG. 16 shows yet another embodiment as an example for ‘Read from Function’, where Function Block (100) reads from many Function Blocks. Where two threads are combined into a single thread (FIG. 16), “Threads Combining Point” (100(1)), moves forward to Make Sound Function Block (100(2)) only after the two threads have finished.

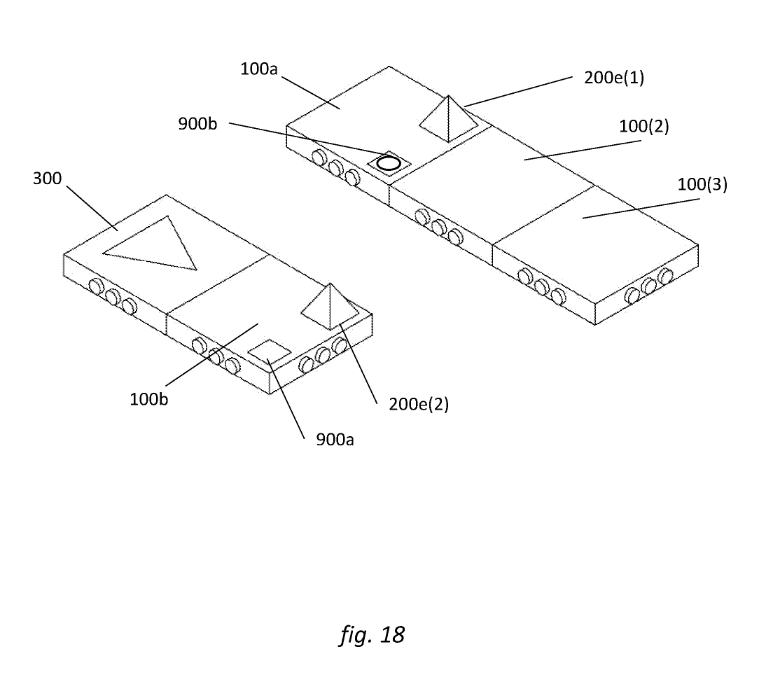

A program may be stored and re-used using a Function Block (100a) with saving capabilities, by pressing the “me store button” (900(b)) (FIG. 18). Function Block (100a) has a Parameter Block (200e(1)) with a unique address and physical shape for identification. The Stored Program is reused by attaching a read Function Block (100b) that knows how to read the specific function using the same unique Parameter Block (200e(2) which is now physically placed on the Function Block 100b, (FIG. 18).

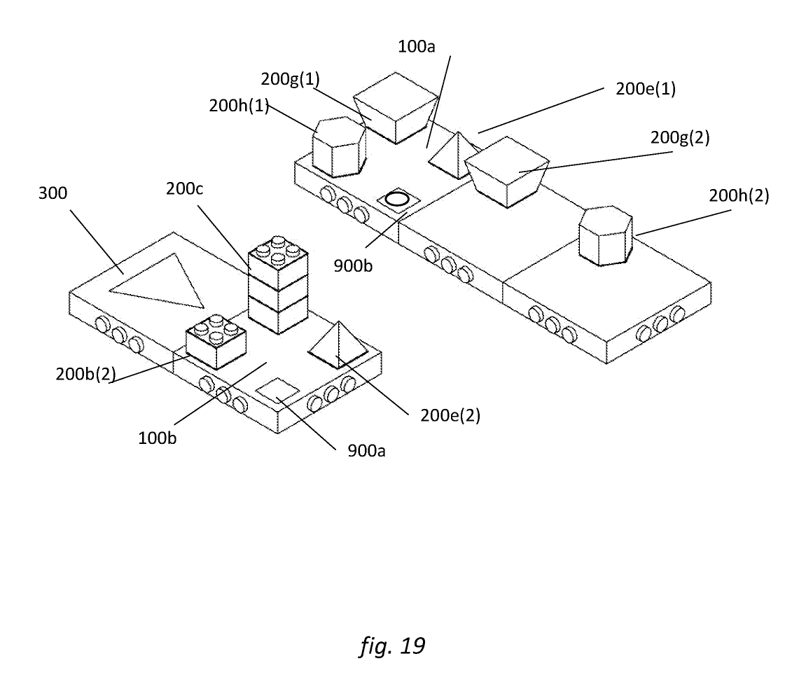

FIG. 19 shows yet another embodiment where in several cases when programmer wants to dynamically change and control the parameters of the stored function using Parameter Blocks (200b(1)), (200b(2). For this matter a Function Block (100a) with several Parameter Blocks (200g(1)), (200h(1) is used.

Each Parameter Block (200g(1)), (200h(2) is a unique pointer to another Parameter Block (200(g(2)), (200(h(2)), which then may be reused by placing Parameter Blocks (200(b(1)), (200c) on read Function Block (100b). The Parameter Blocks (200g(1)), (200h(1), (200g(2)), (200h(2)) may be reused more than once in a plurality of appearances. The saved program may be stored either on Play Block (300) or in save Function Block (100a) by pressing the “me store button” (900(b)).

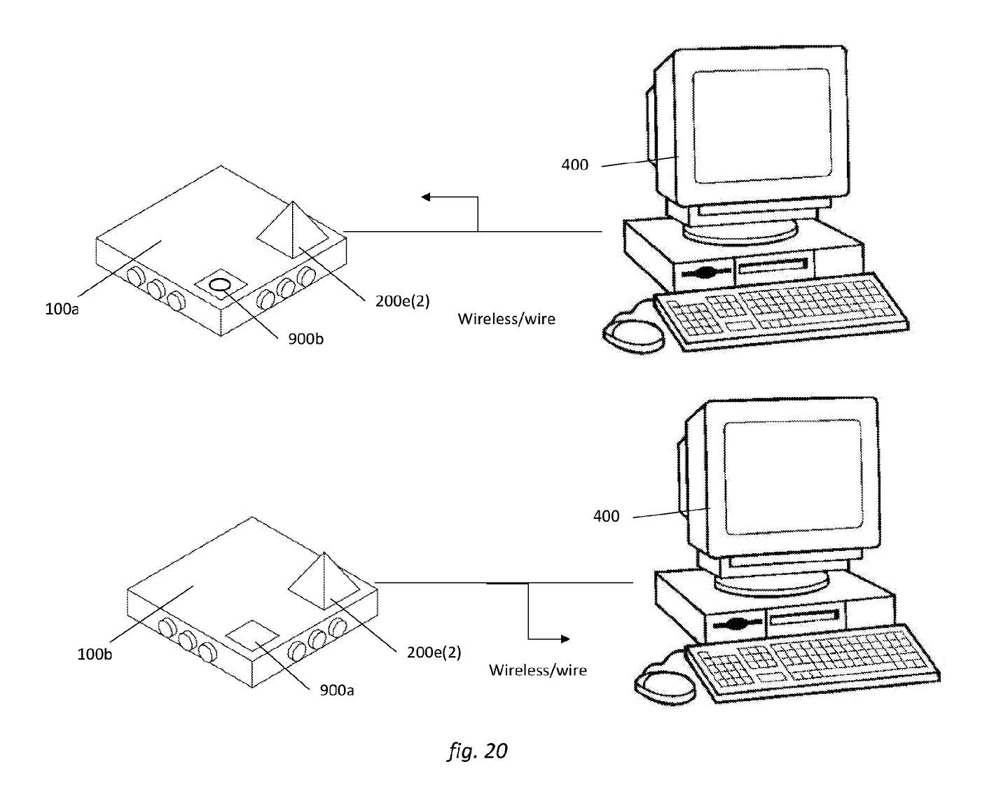

Similarly, a program may be stored or read by communicating with a Programmed Element (400) wireless or wired, (FIG. 20). i.e., reading Function Block (100b) to a computer or saving to a computer, by using save Function Block (100a).

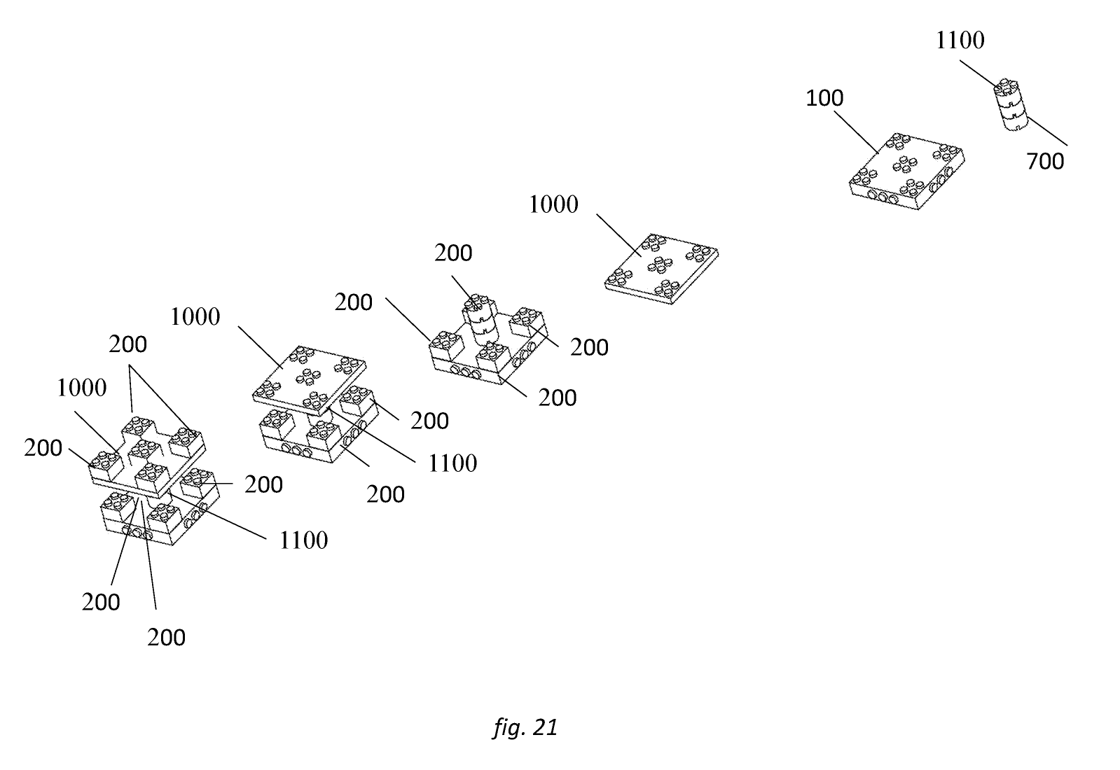

FIG. 21 shows yet another embodiment where in case there is a need to use a large number of Parameter blocks (200)(f), for example in Function Block 100, i.e. larger than the number of available Receptors (800) in Function Block (100) a Parameter Plate (1000) may be used. Parameter Plate (1000) is placed on top of a supporter Block (1000) which contains also Electrical Components (700). The electrical connection and communication is conducted through a Parameter plate (1000) which is electrically wired to the Function Block (100) and includes a place for several Parameter Blocks (200).

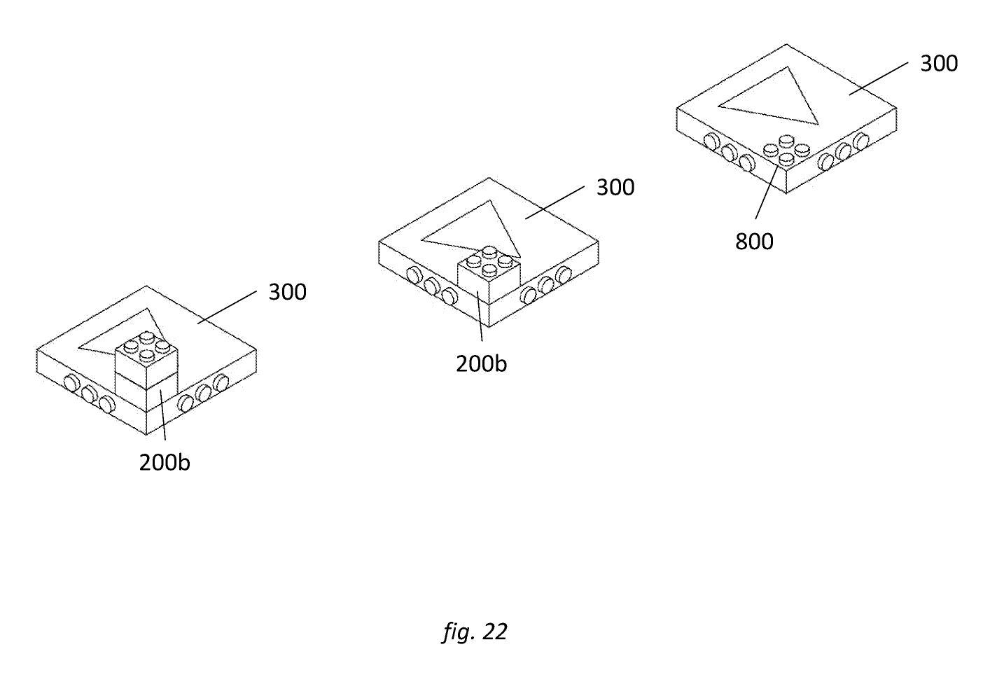

FIG. 22 shows yet another embodiment disclosing how a Play Block (300) may control different Programmed Elements (400) using stackable Parameter Block (200(a)) or non-stackable Parameter Block (200(b)). I.e. changing Parameter Block (200) enables communication with one or more robots, or different types of robots or other Programmed Elements 400.

What is claimed:

1. A physical programming interface with a multi-threaded command sequencing, distinguishing between functions and parameters, by separating functions into different planes (horizontal and vertical), and associating the parameter quantitative size and its functionality with their physical appearance and dimensions. comprising: different kinds of stackable or non-stackable interlock blocks:
three kinds of blocks: play blocks, function blocks, and parameter blocks; and
electrical components; and
a receptor; and
parameter plates; and
Parameter Extension plates; and
programmed elements; and
an automatic error prevention system by one-to-one relationship; and
wherein function blocks comprise:
a unique function block (me button);
a read function blocks; and
save function blocks, and
Wherein interlock blocks comprise spring-based connectors over a function block, transmitting data and current flow between connected function blocks and play blocks; and
Wherein the value of parameter block is read by electrical components.

2. A system of claim 1 wherein function block has a special parameter receptor suitable to one or more parameter blocks having different geometry shapes, wherein receptor's upper surface fits the shape of parameter block bottom surface.

3. A system of claim 1 wherein parameter block has correlation between its physical dimension (height and width) and its logical value Influence is effected by stacking parameter blocks or by using higher or wider parameter blocks.

4. A system of claim 1 wherein mixed stackable parameter and function blocks may be used, with and/or without spring-based connectors.

5. A system of claim 1 wherein a code thread-branching may be preform with any function block and/or play block.

6. The system of claim 5 wherein the number of thread-brunching in each branching-point is set by the number of walls of each shape, subtracting 1.

7. A system of claim 1 wherein pointers to other function blocks may be performed by using parameters blocks as variables.

8. A system of claim 1 wherein run-time running indication is indicated by lightning up the function blocks when a programmed element is preforming during run-time operation.

9. A system of claim 1 wherein an error prevention indication lights up a function block when a wrong parameter block has been placed on a function block.

10. A system of claim 1 wherein an error prevention indication lights up when there is a logical error in function flow.

11. A system of claim 1 wherein a function block reads from multiple function blocks.

12. A system of claim 1 wherein a Me button is positioned on a function block allowing user to run a specific function block out of a series of connected function blocks without activating the entire program sequence.

13. A system of claim 1 wherein a Me button is positioned on a function block allowing the user to run a set of function blocks, such as open loop, close loop, and all other function blocks contained in between, without activating the rest of the function blocks which are not contained in between.

14. A system of claim 1 wherein a function block, reads from multiple function blocks

15. A system of claim 1 wherein a program made out of several function blocks and parameter blocks may be stored using save function block.

16. The system of claim 14 wherein memory for stored functions may be placed on read function blocks, on play block or on programmed element.

17. The system of claim 1 5 wherein stored programs may be read by read function blocks and further repeat the stored program.

18. The system of claim 16 wherein stored programs may be used for changing the values of parameter blocks.

19. The system of claim 1 wherein parameter plates are used to control a large number of parameter blocks.

20. The system of claim 1 wherein programmed elements may be controlled by stackable or non-stackable parameter blocks in plural or single manner.

21. The system of claim 1 wherein play blocks communicate with plural different programmed elements in parallel.
